(19) United States
(12) Patent Application Publication
(10) Pub. No.: US 2026/0286190 A1
(43) Pub. Date: Sep. 24, 2026

(54) ROLLER-TYPE BOTTOM TAPE IRON WITH REDUCED ADHESIVE BUILDUP AT TAIL END OF IRON SECTION

(71) Applicant: TOKYO WELD CO., LTD., Tokyo-to (JP)

(72) Inventors: Katsuyoshi KODERA, Tokyo-to (JP); Norihiro OKABAYASHI, Tokyo-to (JP)

(73) Assignee: TOKYO WELD CO., LTD., Tokyo-to (JP)

(21) Appl. No.: 19/571,077

(22) Filed: Mar. 18, 2026

(30) Foreign Application Priority Data
Mar. 19, 2025 (JP) 2025-044780

(51) Int. Cl. C09J 7/21; C09J 7/35

(52) U.S. Cl. CPC C09J 7/21; C09J 7/35; C09J 2203/326; C09J 2400/283

(57) ABSTRACT

To manufacture a carrier tape accurately and rapidly. A roller-type bottom tape iron with reduced adhesive buildup at a tail end of a presser section has a bottom tape iron 20 that thermally bonds a bottom tape 2 to a substrate 1, and a conveyance roller positioned opposite to the bottom tape iron 20, with the substrate 1 and the bottom tape 2 being sandwiched therebetween. The conveyance roller 15 includes a small-diameter upstream conveyance roller 15a and a large-diameter downstream conveyance roller 15b.

### TECHNICAL FIELD

The present disclosure relates to a roller-type bottom tape iron with reduced adhesive buildup at a tail end of a presser section, which produces a carrier tape for storing workpieces by thermally bonding a bottom tape onto a paper substrate having openings.

### BACKGROUND ART

A carrier tape for storing workpieces has been conventionally known, which stores and supplies chip-type electronic components (also referred to as workpieces).

Such a carrier tape for storing workpieces is obtained by preparing a paper substrate having openings, and thermally bonding a bottom tape onto the substrate to seal the openings by the bottom tape.

In this case, the carrier tape is manufactured by laying the bottom tape over the substrate, and by thermally bonding the substrate and the bottom tape between a guide plate and a bottom tape iron.

However, no technology has been conventionally developed to rapidly and accurately manufacture a carrier tape for storing workpieces.

### PRIOR ART DOCUMENTS

### Patent Documents

[Patent Document 1] JP 3880799 B
[Patent Document 2] JP 3920062 B

### SUMMARY OF INVENTION

The present disclosure has been made in consideration of such circumstances, and the object thereof is to provide a roller-type bottom tape iron with reduced adhesive buildup at a tail end of a presser section, which can rapidly and accurately manufacture a carrier tape for storing workpieces.

The present disclosure provides a roller-type bottom tape iron with reduced adhesive buildup at a tail end of a presser section, comprising: a paper carrier tape; a bottom tape with an adhesive, to be attached to the paper carrier tape; a bottom iron that thermally bonds the bottom tape to the carrier tape; and a plurality of rollers provided opposite to the bottom iron, with the carrier tape and the bottom tape being sandwiched therebetween; wherein: the bottom iron has a presser section to be brought into contact with the bottom tape; the plurality of rollers are rotated in a traveling direction of the carrier tape; the carrier tape, the presser section of the bottom iron, and a traveling direction of cylindrical surfaces of the plurality of rollers guiding a surface of the carrier tape are parallel to each other; the carrier tape and the bottom tape are thermally bonded while they are traveling linearly; and a diameter of a roller of the plurality of rollers, which is upstream in the traveling direction of the carrier tape, is smaller than a diameter of a roller of the plurality of rollers, which is downstream in the traveling direction of the carrier tape.

The present disclosure provides the roller-type bottom tape iron with reduced adhesive buildup at a tail end of a presser section, wherein the presser section includes a pair of pressers, and each presser has a tapered shape whose distal end portion has a width which gradually narrows toward the end along the traveling direction.

The present disclosure provides the roller-type bottom tape iron with reduced adhesive buildup at a tail end of a presser section, wherein a cooling part is provided at a final end portion of the bottom iron in the traveling direction of the carrier tape.

Specific and detailed description of the present disclosure is as follows.
1. A paper carrier tape 1A, lower surfaces 22a of a pair of pressers 22 of a bottom tape iron 20, and a cylindrical surface of a roller 15 that guides a lower surface of the paper carrier tape 1A lie in a horizontal plane to facilitate heating the bottom tape 2 and applying pressure thereto. Thus, a temperature set for the bottom tape iron 20 can be lowered.
2. There are six rollers 15 in a groove (in a guide plate 35) which is subjected to pressure from the bottom tape iron 20, and four downstream rollers 15 are configured to receive a load of the bottom tape iron 20. This structure can reduce running resistance of the paper carrier tape 1A, and is advantageous for high-speed running.
3. Two rollers 15a to which the bottom tape 2 is supplied first is provided for preheating, and have a slightly smaller diameter (0.06 mm smaller in diameter in design).
4. Four rollers 15b subsequent thereto function as pressure rollers.
5. A load of the bottom tape iron 20 has been conventionally received by a flat surface. However, according to the present disclosure, four pressure rollers 15b (φ 8 mm) receive the pressure from the bottom tape iron 20. This increases a surface pressure and makes it easier to achieve sufficient surface pressure to fully depress an uneven surface of the paper carrier tape 1A. Thus, the surface pressure increases by about 8 to 9 times. In this case, the rollers are spaced at 9 mm intervals, and a width of the roller top surface is 1 mm.
6. Increase in surface pressure on the paper carrier tape 1A allows the temperature set for the bottom tape iron 20 to be lowered, whereby adhesive's fluidity can be reduced. In addition, adhesive blowout from tail ends 22e of the pair of pressers 22 of the bottom tape iron 20 can be reduced.
7. Since a maximum pressure point on the paper carrier tape 1A is a roller surface, a cylindrical surface of the downstream roller 15b is spaced away from the tail end 22e of the presser 22 of the bottom tape iron 20, and thus no pressure is applied to a final end of the bottom tape iron 20. This reduces adhesive blowout caused by the pressure applied to the paper carrier tape 1A.

In addition, a conventional presser has a narrow rectangular shape when seen from the bottom tape 2. However, in order to deal with adhesive blowout to a side surface of the bottom tape iron 20 during application of pressure, the presser 22 has an upstream tapered portion 22b which is tapered at 0.8 degrees. This delays heating of the adhesive to thereby prevent adhesive blowout to the side surface of the bottom tape iron 20.

In addition, the tail end 22e of the presser 22 is provided with a downstream tapered portion 22c which is tapered at 4 degrees, to restrict the adhesive blowout location to the widthwise center. In this case, there may be adhesive blowout at the tip of the downstream taper section 22c, but this is a small amount of adhesive and thus can be ignored.
8. A pressing force for thermal bonding by the bottom tape iron 20 is generated by an air cylinder (double-acting) 28, applying thrust perpendicular to a tape plane of the bottom tape 2.
9. The conveyance roller holder 13 holding the roller 15 can be opened and closed downward. Thus, the presser 22 of the bottom tape iron 20 can be exposed upon cleaning, and can be cleaned while viewing the entire presser 22.
10. Due to the above structure, the height of the presser 22 of the bottom tape iron 20 can be adjusted to an optimal parallel position with respect to the rollers 15, simply by pressing and fixing the bottom tape iron 20 against the roller 15.
11. All the above features can completely eliminate conventionally occurring issues such as lift up of the bottom tape 2.

As described above, the present disclosure can manufacture rapidly and accurately a carrier tape for storing workpieces.

### BRIEF DESCRIPTION OF THE DRAWINGS

FIG. 1 is a side cross-sectional view showing a carrier-tape manufacturing apparatus.

FIG. 2 is a front cross-sectional view showing the carrier-tape manufacturing apparatus.

FIG. 3 is a plan view showing a bottom tape iron.

FIG. 4 is a side view showing the bottom tape iron.

FIG. 5 is a bottom view showing the bottom tape iron.

FIG. 6 is a perspective view showing the bottom tape iron.

FIG. 7 is a front cross-sectional view showing a conveyance roller and the bottom tape iron.

FIG. 8 is a cross-sectional view showing a substrate and the bottom tape iron.

FIG. 9 is a view showing a state where workpieces are stored in a carrier tape.

### MODE FOR CARRYING OUT THE INVENTION

A roller-type bottom tape iron with reduced adhesive buildup at a tail end of a presser section (also referred to as carrier-tape manufacturing apparatus in the specification) will be described hereunder with reference to the drawings.

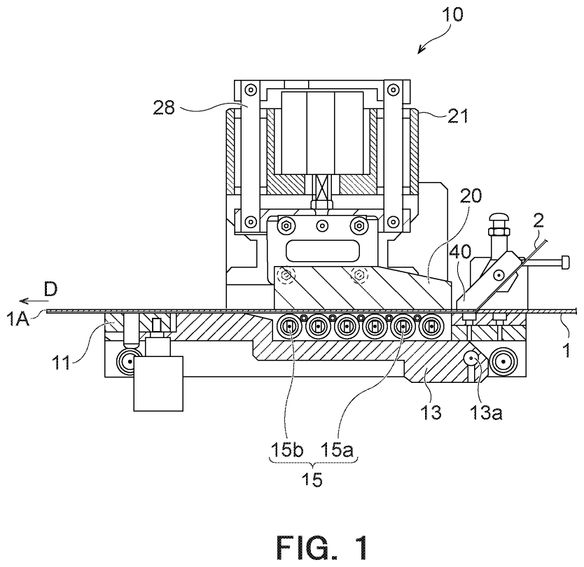

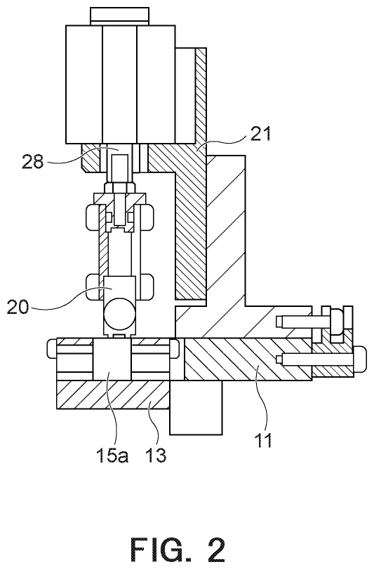

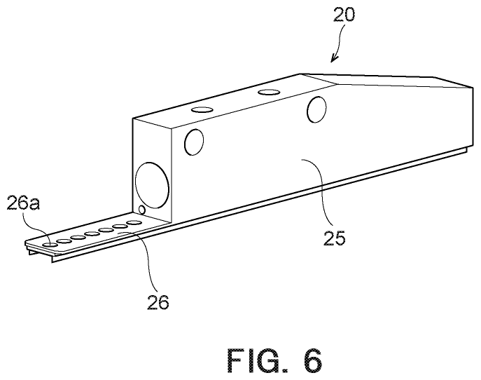

FIGS. 1 to 9 are views showing an embodiment of a carrier-tape manufacturing apparatus according to the disclosure.

First, a carrier tape for storing workpieces 1A, which stores and supplies chip-type electronic components (also referred to as workpieces) is described referring to FIG. 9

As shown in FIG. 9, the carrier tape 1A is obtained by preparing a substrate 1 having openings 3, and thermally bonding a bottom tape 2 onto the substrate 1.

As shown in FIG. 9, the carrier tape 1A is made of paper a has openings 3. Workpieces 5 are stored in the openings 3 of the carrier tape 1A. A top tape 6 for sealing the openings 3 is attached onto the carrier tape 1A with the workpieces being stored in the openings 3. Then, the carrier tape 1A is delivered to subsequent processes.

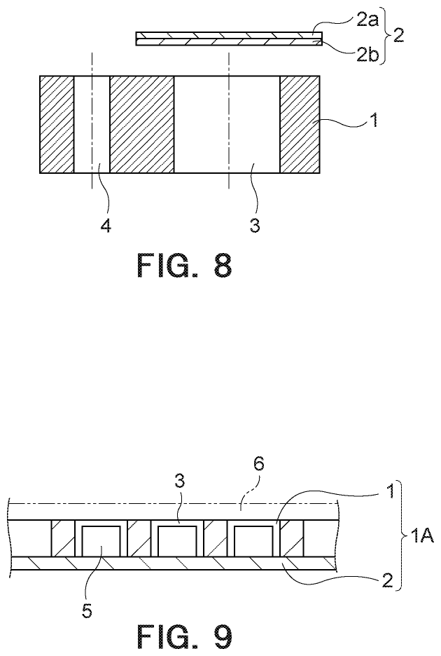

In this embodiment, the substrate 1 of the carrier tape 1A is made of paper. The bottom tape 2 includes a paper layer 2a, and a polyethylene resin layer (referred to also as adhesive hereunder) 2b to be positioned nearer to the substrate 1 (see FIG. 8).

Next, a carrier-tape manufacturing apparatus 10 for manufacturing the carrier tape for storing workpieces 1A is described referring to FIGS. 1 to 8.

In this embodiment, in the manufacture of the carrier tape 1A, the substrate 1 is conveyed, the bottom tape 2 is thermally bonded to an upper surface of the substrate 1 to obtain the carrier tape 1A (see FIG. 1). On the other hand, when the carrier tape 1A is used to store workpieces 5 in the openings 3 of the carrier tape 1A, the bottom tape 2 is positioned on a bottom surface of the substrate 1 (see FIG. 9).

In this embodiment, “upper surface”, “lower surface”, “up/above” and “down/below” mean “upper surface”, “lower surface”, “up/above” and “down/below” when the carrier tape 1A is positioned in a state as shown in FIG. 1.

As shown in FIGS. 1 to 8, the carrier-tape manufacturing apparatus 10 is configured to manufacture the carrier tape 1A by thermally bonding the bottom tape onto the paper substrate 1 having openings. Such a carrier-tape manufacturing apparatus 10 includes: a plurality of conveyance rollers 15, e.g., six conveyance rollers 15 that convey the substrate 1 and the bottom tape 2, which are laid one on the other, along a conveyance direction D; and a bottom tape iron 20 positioned opposite to the six conveyance rollers 15, with the substrate 1 and the bottom tape 2 being sandwiched therebetween.

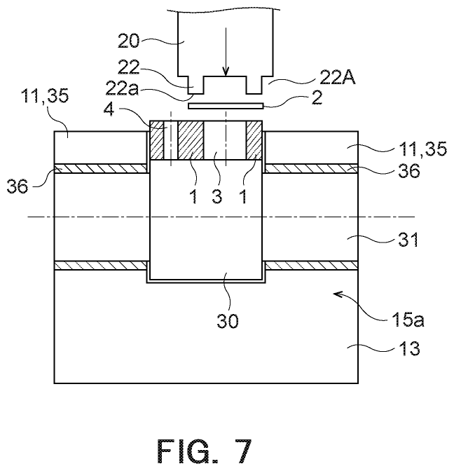

The plurality of conveyance rollers 15 have two upstream conveyance rollers 15a, which are positioned upstream in the conveyance direction, and four downstream conveyance rollers 15b, which are positioned downstream in the conveyance direction. Both the upstream conveyance rollers 15a and the downstream conveyance roller 15b are positioned nearer to the substrate 1 (see FIGS. 7 and 8).

Next, the upstream conveyance rollers 15a and the downstream conveyance rollers 15b are further described.

FIG. 7 is a cross-sectional view of the upstream conveyance roller 15a seen along the conveyance direction D. FIG. 8 is an enlarged view showing the substrate 1 and the bottom tape 2 shown in FIG. 7. FIG. 7 shows the cross-section of the upstream conveyance roller 15a, but the downstream conveyance roller 15b has substantially the same structure as the upstream conveyance roller 15a.

As shown in FIGS. 1, 2, 7 and 8, the two upstream conveyance rollers 15a and the four downstream conveyance rollers 15b are all held by a convenance roller holder 13. The conveyance roller holder 13 is pivotably mounted to a base 11 through a pivot shaft 13a. The conveyance roller holder 13 can be rotated with respect to the base 11 between a mounting position where the carrier-tape manufacturing apparatus 10 is being operated, and a standby position where the operation of the carrier-tape manufacturing apparatus 10 is suspended for cleaning the bottom tape iron 20.

In this embodiment, FIG. 1 shows the conveyance roller holder 13 which is at the mounting position where the carrier-tape manufacturing apparatus 10 is being operated. When the operation is suspended for cleaning the bottom tape iron 20, the conveyance roller holder 13 is pivoted downward through the pivot shaft 13a to reach the standby position. By pivoting the conveyance roller holder 13 to the standby position, a lower surface of the bottom tape iron 20 can be exposed so that the lower surface of the bottom tape iron 20 can be cleaned.

The upstream conveyance roller 15a has a roller body 30, and a rotation shaft 31 that supports the roller body 30. The base 11 has a pair of guide plates 35, 35 that guide opposed side edges of the substrate 1. The substrate 1 is conveyed on the upstream conveyance roller 15a, while the side edges of the substrate 1 is guided by the pair of guide plates 35, 35.

The roller body 30 of the upstream conveyance roller 15a is supported by the rotation shaft 31. The rotation shaft 31 is rotatably supported by a bearing 36 positioned between the conveyance roller holder 13 and the pair of guide plates 35, 35 of the base 11.

In this embodiment, the two upstream conveyance rollers 15a and the four downstream conveyance rollers 15b are all supported by the rotation shafts 31. The rotation shafts 31 of the two upstream conveyance rollers 15a and the four downstream conveyance rollers 15b lie in the same horizontal plane.

A roller body 30 of the downstream conveyance roller 15b has a larger diameter than the roller body 30 of the upstream conveyance roller 15a. This allows the downstream conveyance roller 15b to apply greater pressure to the substrate 1 and the bottom tape 2 between the downstream conveyance roller 15b and the bottom tape iron 20, as compared with the upstream conveyance roller 15a.

In this embodiment, the diameter of the roller body 30 of the downstream conveyance roller 15b is 8 mm, for example. On the other hand, the diameter of the roller body 30 of the upstream conveyance roller 15a is 7.94 mm which is 0.06 mm smaller than 8 mm (8−0.06=7.94).

The substrate 1 and the bottom tape 2 are conveyed by the upstream conveyance rollers 15a and the downstream conveyance roller 15b, in such a manner that the substrate 1 is positioned nearer to the upstream conveyance rollers 15a and the downstream conveyance roller 15b, and that the bottom tape 2 is positioned nearer to the bottom tape iron 20 (see FIGS. 7 and 8).

Next, the bottom tape iron 20 is described. As shown in FIGS. 1 to 6, the bottom tape iron 20 is held by a bottom-tape-iron holder 21. The bottom tape iron 20 has at its lower surface (surface nearer to bottom tape 2) a presser section 22A with a pair of pressers 22 that extend along the conveyance direction D and project downward (see FIGS. 1 and 7).

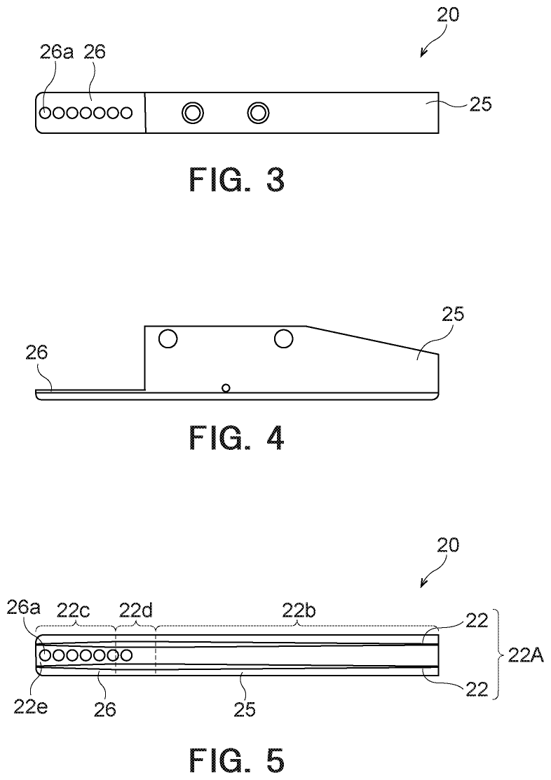

The bottom tape iron 20 has a bottom tape iron body 25 that thermally bonds, between it and the plurality of conveyance rollers 15a, 15b, the substrate 1 and the bottom tape 2, and an extension part 26 that extends downstream of the bottom tape iron body 25 in the conveyance direction and has a thickness smaller than the bottom tape iron body 25 (see FIGS. 3 to 6).

The bottom tape iron body 25 has a built-in heater (not shown) and is configured to thermally bond, between it and the conveyance rollers 15a, 15b, the substrate 1 and the bottom tape 2. On the other hand, the extension part 26 is positioned downstream of the bottom tape iron body 25 in the conveyance direction and has a small thickness. The extension part 26 has, e.g., seven cooling opening 26a formed along the conveyance direction D. Thus, heat remaining in the substrate 1, which has been heated by the bottom tape iron body 25, is released outward from the cooling openings 26a.

Next, the pair of pressers 22, 22 formed on the lower surface of the bottom tape iron 20 are described referring to FIG. 5.

As shown in FIG. 5, each of the pair of pressers 22 has an elongate shape and extends on the lower surface of the bottom tape iron 20 along the conveyance direction. Heat is transferred from the bottom tape iron 20 to the bottom tape 2 through the pair of pressers 22.

Lower surfaces 22a of the pair of pressers 22 also extend along a horizontal plane. Thus, the pair of pressers 22 lightly clamp, between them and the small-diameter upstream conveyance rollers 15a, the substrate 1 and the bottom tape 2, and heat the bottom tape 2. In addition, the pair of pressers 22 strongly apply pressure, between them and the large-diameter downstream conveyance rollers 15b, to the substrate 1 and the bottom tape 2, and heat the bottom tape 2.

From the above, it can be understood that the two upstream conveyance rollers 15a of the conveyance rollers 15 function as preheating rollers that apply heat to the bottom tape 2, and the downstream conveyance rollers 15b function as pressure rollers that apply heat to the bottom tape 2 while applying pressure to the substate 1 and the bottom tape 2.

Each of the pair of pressers 22 formed on the lower surface of the bottom tape iron 20 has an upstream tapered portion 22b, which is formed upstream in the conveyance direction and has a width that gradually increases along the conveyance direction D, and a downstream tapered portion 22c, which is formed downstream in the conveyance direction D and has a width that gradually decreases along the conveyance direction D. An intermediate portion 22d having the same width is formed between the upstream tapered portion 22a and the downstream tapered portion 22c.

Since the upstream tapered portion 22b has a taper angle of 0.8 degrees, its width gradually increases along the conveyance direction.

Thus, when the upstream tapered portions 22b of the pair of pressers 22 apply pressure to the bottom tape 2 and heat the same, a heated area width of the bottom tape 2 is initially narrow. Then, the heated area width of the bottom tape 2 gradually increases, as the bottom tape 2 travels in the conveyance direction. This can prevent overheating of the side edges of the heated area of the bottom tape 2, to thereby reliably prevent the resin layer 2b of the bottom tape 2 from being melted at the side edges of the heated area to flow outward therefrom in the width direction.

Namely, suppose that the pair of pressers 22 do not have the upstream tapered portions 22b so that they have a rectangular shape in a plan view. In this case, when the bottom tape 2 is heated by the pair of pressers 22, the heated area width of the bottom tape 2 is ever unchanged. Thus, when the bottom tape 2 travels in the conveyance direction, the heated area of the bottom tape 2 is continuously heated at the same width. Then, there is a possibility that the side edges of the heated area is overheated, and that the resin layer 2b of the bottom tape 2 is thus melted at the side edges of the heated area to flow outward therefrom in the width direction. However, according to this embodiment, the upstream tapered portion 22b as described above can prevent the resin layer 2b of the bottom tape 2 from being melted to flow outward in the width direction.

The downstream tapered portion 22c formed on each presser 22 has a taper angle of 4 degrees, and its width gradually decreases along the conveyance direction. The downstream tapered portion 22c is provided on the lower surface 22a of the presser 22 at a position corresponding to the extension part 26. Since such a downstream tapered portion 22c is provided on the presser 22, the heated area of the bottom tape 2 can be converged along the conveyance direction D toward the center in the width direction. This can prevent the resin layer 2b from flowing outward in the width direction from the side edges of the heated area of the bottom tape 2. Thus, there is no possibility that the resin layer (also referred to as adhesive) builds up on the presser 22, in particular, a tail end 22e of the presser 22.

The bottom tape iron 20 is generally mounted on the bottom tape iron holder 21 so as to be movable in the up and down direction. The bottom tape iron holder 21 has a drive cylinder 28. The bottom tape iron 20 can be moved in the up and down direction by means of the drive cylinder 28.

As shown in FIGS. 1 to 5, the bottom tape iron body 25 of the bottom tape iron 20 is located at a position corresponding to the plurality of conveyance rollers 15, while the extension part 26 is located away from the plurality of conveyance rollers 15. Thus, the bottom tape iron body 25 heats, between it and the plurality of conveyance rollers 15, the substrate 1 and the bottom tape 2, and applies pressure thereto. On the other hand, the extension part 26 does not press, between it and the plurality of conveyance rollers 15, the substrate 1 and the bottom tape 2, but mainly functions to cool the heated area of the bottom tape 2 by means of the cooling openings 26a.

Next, an operation of the embodiment as structured above is described.

As shown in FIGS. 7 and 8, the substrate 1 having the openings 3 and positioning holes 4, which are provided at predetermined intervals along the conveyance direction, is prepared first.

Each opening 3 of the substrate 1 is a space to be sealed by the bottom tape 2 to store therein a workpiece 5. A positioning pin, not shown, is inserted into each positioning hole 4.

Such a substrate 1 is a paper substrate having a thickness of 0.3 to 1.1 mm.

The bottom tape 2 is laid over the substrate 1 as structured above, and the substrate 1 together with the bottom tape 2 is delivered to the carrier-tape manufacturing apparatus 10, and is conveyed along the conveyance direction D (see FIG. 1). In this case, the side edges of the substrate 1 and the bottom tape 2 are guided by the guide plates 35.

In this embodiment, the bottom tape 2 has the paper layer 2a having a thickness of 20 μm, and the polyethylene resin layer (also referred to as adhesive) 2b having a thickness of 20 μm and provided on the paper layer 2a. The resin layer 2b of the bottom tape 2 faces the substrate 1.

The paper substrate 1 is conveyed along the horizontally extending conveyance direction D. The bottom tape 2 is delivered onto the substrate 1 through a bottom tape guide 40 so as to be laid over the substrate 1.

Then, the substrate 1 and the bottom tape 2 are inserted a space between the bottom tape iron 20 and the plurality of conveyance rollers 15, and are thermally bonded between the bottom tape iron 20 and the plurality of conveyance rollers 15.

Since the bottom tape 2 is thermally bonded onto the substrate 1, the openings 3 are sealed by the bottom tape 2, so that the carrier tape 1A is manufactured.

During this time, the substrate 1 and the bottom tape 2 are clamped and heated between the pair of pressers 22 of the bottom tape iron 20 and the plurality of conveyance rollers 15. The pair of pressers 22 are heated by heat from a heater provided on the bottom tape iron body 25 of the bottom tape iron 20, so that the bottom tape 2 is heated by the pair of pressers 22. Thus, the bottom tape 2 is thermally bonded to the substrate 1 by means of the resin layer 2b.

In this embodiment, a melting point of the polyethylene resin layer 2b is about 100° C. Thus, a temperature of the pair of pressers 22 is set to approximately 130° C., which is slightly higher than the melting point of the resin layer 2b.

The substrate 1 and the bottom tape 2 first reach the upstream conveyance rollers 15a, and are pressed between these upstream conveyance rollers 15a and the lower surfaces 22a of the pair of pressers 22. As described above, the upstream conveyance roller 15a has a relatively small diameter, the substrate 1 and the bottom tape 2 are lightly clamped between the upstream conveyance rollers 15a and the lower surfaces 22a of the pair of pressers 22, and the pair of pressers 22 apply preheat to the bottom tape 2.

Then, the substrate 1 and the bottom tape 2 reach the downstream conveyance rollers 15b, and are pressed between these downstream conveyance rollers 15b and the lower surfaces 22a of the pair of pressers 22. In this case, since the downstream conveyance roller 15b has relatively a large diameter than the upstream conveyance roller 15a, the substrate 1 and the bottom tape 2 are strongly clamped between the downstream conveyance rollers 15b and the lower surfaces 22a of the pair of pressers 22. Namely, the substrate 1 and the bottom tape 2 are more strongly subjected to pressure between the downstream conveyance rollers 15b and the lower surfaces 22a of the pair of pressers 22 as compared with the upstream conveyance rollers 15a, and are more strongly heated by heat from the pair of pressers 22. In this manner, the bottom tape 2 is thermally bonded onto the substrate 1, so that the openings 3 are sealed by the bottom tape 2.

During this time, the substrate 1 and the bottom tape are continuously delivered to the carrier-tape manufacturing apparatus 10 along the conveyance direction D, whereby the carrier tape 1A is obtained by the carrier-tape manufacturing apparatus 10.

Next, behavior of the pair of pressers 22 of the bottom tape iron 20 during the operation of the carrier-tape manufacturing apparatus 10 is described.

Each of the pair of pressers 22 of the bottom tape iron 20 has the upstream tapered portion 22b, which is formed upstream in the conveyance direction and has a width that gradually increases along the conveyance direction D, and the downstream tapered portion 22c, which is formed downstream in the conveyance direction and has a width that gradually decreases along the conveyance direction D. The intermediate portion 22d having the same width is formed between the upstream tapered portion 22a and the downstream tapered portion 22c.

Thus, when the bottom tape 2 is subjected to pressure and heated by the upstream tapered portions 22b of the pair of pressers 22, the heated area width of the bottom tape 2 can be gradually increased as it travels in the conveyance direction, to thereby prevent overheating of the side edges of the heated area of the bottom tape 2. This can prevent the resin layer 2b of the bottom tape 2 from being melted at the side edges of the heated area of the bottom tape 2 to flow on both sides of each presser 22.

Each of the pair of pressers 22 of the bottom tape iron 20 has the downstream tapered portion 22c, which is formed downstream in the conveyance direction and has a width that gradually decreases along the conveyance direction D. The thus downstream tapered portion 22c can converge the heated area of the bottom tape 2 along the conveyance direction D toward the center in the width direction. This can prevent the resin layer 2b from flowing from the side edges of the heated area of the bottom tape 2 on both sides of each presser 22. Thus, there is no possibility that the resin layer (also referred to as adhesive) builds up on the presser 22, in particular, the tail end 22e of the presser 22.

In this manner, the carrier tape 1A can be manufactured using the carrier-tape manufacturing apparatus 10.

During the operation of the carrier-tape manufacturing apparatus 10, the conveyance roller holder 13 is at the mounting position where the plurality of conveyance rollers 15 are aligned horizontally (see FIG. 1).

Then, after completion of the operation of the carrier-tape manufacturing apparatus 10, the conveyance roller holder 13 is pivoted downward through the pivot shaft 13a to move downward the conveyance roller holder 13 and the plurality of conveyance rollers 15 held by the conveyance roller holder 13 apart from the bottom tape iron 20.

After the conveyance roller holder 13 and the plurality of conveyance rollers 15 have been moved downward apart from the bottom tape iron 20 in this manner, the lower surfaces 22a of the pair of pressers 22 formed on the bottom tape iron 20 are exposed. The thus exposed pair of presses 22 and the lower surfaces 22a can be easily cleaned from below, to thereby increase a heat transfer coefficient between the pair of pressers 22 and the bottom tape 2.

If necessary, the bottom tape iron 20 held by the bottom tape iron holder 21 can be removed from below, and can be replaced with a new bottom tape iron 20.

During the operation of the carrier-tape manufacturing apparatus 10, the bottom tape 2 is heated by the bottom tape iron 20 to be thermally bonded onto the substrate 1, so that the carrier tape 1A can be obtained. The heat remaining in the bottom tape 2 of the carrier tape 1A is released through the cooling openings 26a formed in the extension part 26 of the bottom tape iron 20. In this manner, the carrier tape 1A is cooled.

According to the this embodiment as described above, the substrate 1 and the bottom tape 2 are conveyed by the plurality of conveyance rollers 15, while the paper substrate 1 and the bottom tape 2 are clamped and heated between the bottom tape iron 20 and the plurality of conveyance rollers 15, so that the bottom tape 2 can be thermally bonded onto the substrate 1. Since the substrate 1 and the bottom tape 2 can be subjected to pressure between the plurality of conveyance rollers 15 and the bottom tape iron 20, a load per unit area (surface pressure) applied to the substrate 1 and bottom tape 2 can be increased, for example, by about 5 to 10 times, as compared with a case in which, for example, the substrate 1 and the bottom tape 2 are conveyed on a flat guide plate, and the substrate 1 and the bottom tape 2 are subjected to pressure between the flat guide plate and the bottom tape iron.

Since the substrate 1 and the bottom tape 2 can be subjected to such a large surface pressure between the plurality of conveyance rollers 15 and the bottom tape iron 20, even when the surface of the substrate 1 is slightly uneven, the bottom tape 2 can be thermally bonded onto the substrate 1 reliably without being affected by the unevenness. In this manner, the bottom tape 2 can be thermally bonded onto the substrate 1 reliably, and the substrate 1 and the bottom tape 2 can be clamped and conveyed between the plurality of conveyance rollers 15 and the bottom tape iron 20. Thus, the substrate 1 and the bottom tape 2 can be rapidly conveyed, and the substrate 1 can be prevented from being damaged while it is conveyed.

Namely, when the substrate 1 and the bottom tape 2 are conveyed on a flat guide plate, there is a possibility that a first surface of the substrate 1, onto which the top tape 6 is to be attached in a subsequent process, could rub on the guide plate to be damaged. However, according to this embodiment, there is no possibility that the substrate 1 is damaged while the substrate 1 and the bottom tape 2 are conveyed. In addition, since the bottom tape 2 can be thermally bonded onto the substrate 1 reliably, the paper carrier tape 1A can be accurately manufactured. In this case, the bottom tape 2 does not lift up from the carrier tape 1A.

As described above, since the substrate 1 and the bottom tape 2 can be subjected to such a large surface pressure between the plurality of conveyance rollers 15 and the bottom tape iron 20, a temperature value set for the bottom tape iron 20 can be lowered to reduce an amount of heat applied to the bottom tape 2. For example, when a melting point of the polyethylene forming the resin layer 2b of the bottom tape 2 is about 100° C., the temperature of the bottom tape iron 20 is set so that the temperature of the pair of pressers 22 is about 130° C.

This can prevent the resin layer 2b of the bottom tape 2 from being excessively heated to thereby prevent a large amount of the resin layer (also referred to as adhesive) 2b from being melted to flow on both sides of each presser 22. Thus, there is no possibility that the resin layer 2b of the bottom tape 2 builds up on the presser 22, in particular, the tail end 22e of the presser 22.

The plurality of conveyance rollers 15 include the small-diameter upstream conveyance rollers 15a and the large-diameter downstream conveyance rollers 15b. While the small-diameter upstream conveyance rollers 15a are lightly clamping, between them and the bottom tape iron 20, the substrate 1 and the bottom tape 2, the bottom tape iron 20 applies preheat to the bottom tape 2. Then, the large-diameter downstream conveyance rollers 15b strongly clamp, between then and the bottom tape iron 20, the substrate 1 and the bottom tape 2, and apply pressure thereto, whereby the bottom tape 2 can be thermally bonded onto the bottom tape 2 reliably between the downstream conveyance rollers 15b and the bottom tape iron 20.

In this manner, the bottom tape 2 is preheated between the upstream conveyance rollers 15a and the bottom tape iron 20, and then the bottom tape 2 is thermally bonded onto the substrate 1 between the downstream conveyance rollers 15b and the bottom tape iron 20. Namely, the bottom tape 2 is gradually heated by the upstream conveyance rollers 15a, and then the bottom tape 2 is thermally bonded to the substrate 1 by the downstream conveyance rollers 15b, which enables a smooth thermal bonding operation.

Each of the pair of pressers 22 formed on the lower surface of the bottom tape iron 20 has the upstream tapered portion 22b, which is formed upstream in the conveyance direction and has a width that gradually increases along the conveyance direction D, and the downstream tapered portion 22c, which is formed downstream in the conveyance direction and has a width that gradually decreases along the conveyance direction D. According to this embodiment, the upstream tapered portion 22b can prevent additional heat at the side edges of the heated area of the bottom tape 2, to thereby reliably prevent the resin layer 2b of the bottom tape 2 from being melted at the side edges of the heated area of the bottom tape 2 to flow on both sides of each presser 22.

The downstream tapered portion 22c can converge the heated area of the bottom tape 2 along the conveyance direction D toward the center in the width direction. This reduces buildup of the resin layer (also referred to as adhesive) on the presser 22, in particular, the tail end 22e of the presser 22.

As described above, the bottom tape 2 is heated by the bottom tape iron 20, and the heated bottom tape 2 is thermally bonded onto the substrate 1, so that the carrier tape 1A can be obtained. In this case, the heat remaining in the bottom tape 2 of the carrier tape 1A is reliably released through the cooling openings 26a provided in the extension part 26 of the bottom tape iron 20.

In addition, the conveyance roller holder 13 holding the plurality of conveyance rollers 15 can be pivoted downward through the pivot shaft 13a. Thus, after completion of the operation of the carrier-tape manufacturing apparatus 10, the conveyance roller holder 13 is pivoted downward through the pivot shaft 13a. Then, the conveyance rollers 15 and the conveyance roller holder 13 are moved downward apart from bottom tape iron 20. Then, the plurality of conveyance rollers 15 and the conveyance roller holder 13 are moved apart from the bottom tape iron 20. Thus, the lower surfaces 22a of the pair of pressers 22 formed on the bottom tape iron 20 are exposed. The thus exposed pair of presses 22 and the lower surfaces 22a can be easily cleaned from below, to thereby increase a heat transfer coefficient between the pair of pressers 22 and the bottom tape 2.

Further, if necessary, the bottom tape iron 20 held by the bottom tape iron holder 21 can be removed from below, and can be replaced with a new bottom tape iron 20.

Furthermore, the rotations shafts 31 of the upstream conveyance rollers 15a and the downstream conveyance rollers 15b forming the plurality of conveyance rollers 15 lie in the same horizontal plane. Similarly, the lower surfaces 22a of the pair of pressers 22 of the bottom tape iron 20 lie in the same horizontal plane.

Thus, when the bottom tape iron 20 is moved downward b the drive cylinder 28, the lower surfaces 22a of the pair of pressers 22 of the bottom tape iron 20 are brought into contact with the large-diameter downstream conveyance rollers 15b first. By simply stopping at this position the lowering of the bottom tape iron 20 by the drive cylinder 28, positioning between the upstream and downstream conveyance rollers 15a, 15b and the bottom tape iron 20 can be easily adjusted. In this case, the lower surfaces 22a of the pair of pressers 22 of the bottom tape iron 20 and upper ends of the downstream conveyance rollers 15b can be brought to the same horizontal plane.

As described above, this embodiment allows reliable thermal bonding of the bottom tape 2 onto the substrate 1 to enable rapid manufacture of the accurate carrier tape 1A.
1 Substrate
1A Carrier tape
2 Bottom tape
2a Paper layer
2b Resin layer
3 Opening
4 Positioning hole
5 Workpiece
10 Carrier-tape manufacturing apparatus
11 Base
13 Conveyance roller holder
13a Pivot shaft
15 Conveyance roller
15a Upstream conveyance roller
15b Downstream conveyance roller
20 Bottom tape iron
21 Bottom-tape-iron holder
22 Presser
22A Presser section
22a Lower surface
22b Upstream tapered portion
22c Downstream tapered portion
22d Intermediate portion
22e Tail end
25 Bottom tape iron body
26 Extension part
26a Cooling opening
28 Drive cylinder
30 Roller body
31 Rotation shaft
35 Guide plate
36 Bearing
40 Bottom tape guide

1. A roller-type bottom tape iron with reduced adhesive buildup at a tail end of a presser section, comprising:
a paper carrier tape;
a bottom tape with an adhesive, to be attached to the paper carrier tape;
a bottom iron that thermally bonds the bottom tape to the carrier tape; and
a plurality of rollers provided opposite to the bottom iron, with the carrier tape and the bottom tape being sandwiched therebetween;
wherein:
the bottom iron has a presser section to be brought into contact with the bottom tape;
the plurality of rollers are rotated in a traveling direction of the carrier tape;
the carrier tape, the presser section of the bottom iron, and a traveling direction of cylindrical surfaces of the plurality of rollers guiding a surface of the carrier tape are parallel to each other;
the carrier tape and the bottom tape are thermally bonded while they are traveling linearly; and
a diameter of a roller of the plurality of rollers, which is upstream in the traveling direction of the carrier tape, is smaller than a diameter of a roller of the plurality of rollers, which is downstream in the traveling direction of the carrier tape.

2. The roller-type bottom tape iron with reduced adhesive buildup at a tail end of a presser section according to claim 1, wherein
the presser section includes a pair of pressers, and
each presser has a tapered shape whose distal end portion has a width which gradually narrows toward the end along the traveling direction.

3. The roller-type bottom tape iron with reduced adhesive buildup at a tail end of a presser section according to claim 1, wherein
a cooling part is provided at a final end portion of the bottom iron in the traveling direction of the carrier tape.
